(19) United States
(12) Patent Application Publication
(10) Pub. No.: US 2014/0278601 A1
(43) Pub. Date: Sep. 18, 2014

(54) GROUP TRAVEL OPPORTUNITY RECOMMENDATIONS AND RESERVATIONS BASED ON SHARED INTERESTS

(71) Applicant: INTERNATIONAL BUSINESS MACHINES CORPORATION, Armonk, NY (US)

(72) Inventor: Jonathan F. Brunn, Logan, UT (US)

(73) Assignee: INTERNATIONAL BUSINESS MACHINES CORPORATION, Armonk, NY (US)

(21) Appl. No.: 14/071,225

(22) Filed: Nov. 4, 2013

Related U.S. Application Data
(63) Continuation of application No. 13/834,163, filed on Mar. 15, 2013.

(51) Int. Cl. G06Q 10/02; G06Q 50/14

(52) U.S. Cl. CPC G06Q 10/02; G06Q 50/14
USPC 705/5

(57) ABSTRACT

A method for making group opportunity recommendations and reservations may include searching, by a processor, for an opportunity based on at least one shared interest of at least two members of a network. The method may also include transmitting, by the processor, the opportunity to the at least two members of the network in response to finding the opportunity based on the at least one shared interest. The method may further include providing, by the processor, a feature associated with the opportunity that allows each of the at least two members to accept the opportunity based on a condition. The condition may include at least one of accepting the opportunity by another of the at least two members, accepting the opportunity by at least one other designated member of the network, and accepting the opportunity by a preset number of the members of the network.

### CROSS-REFERENCE TO RELATED APPLICATION

This application is a continuation application of U.S. patent application Ser. No. 13/834,163, filed Mar. 15, 2013 the contents of which are incorporated herein by reference in its entirety.

### BACKGROUND

Aspects of the present invention relate to group travel recommendations and reservations, and more particularly to a method and system for making group travel opportunity recommendations and reservations based on shared interests.

People often make decisions as a group and plan travel together. Current advertising models and booking or reservation systems do not adequately facilitate making travel decisions by a group making reservations based on group dynamics. Existing booking systems are predominantly based on individual travelers or groups traveling together from a single origin and with the identical itinerary. Travel services providers, such as airlines or other modes of transportation, may have difficulty relating together groups traveling from multiple different origin cities or traveling from the same origin on different reservations. Accordingly, the service provider may be unable to make use of information about individuals traveling together on separate reservations to promote special offers or to make flight planning and resource allocation decisions.

Advertisements for travel are common on social networking sites. Systems providing the advertisements may scan for keywords on the social network site related to destinations or activities and offer advertisements based on those keywords. This level of advertisement is typically not very personalized to a particular member of the social network and does not consider other members or contacts that the particular member is linked to on the social network. Accordingly, this linkage or information about an individual's network may not be utilized or is not utilized efficiently to cross-sell and promote opportunities involving multiple people.

### BRIEF SUMMARY

According to an aspect of the present invention, a method for making group opportunity recommendations and reservations may include searching, by a processor, for an opportunity based on at least one shared interest of at least two members of a network. The method may also include transmitting, by the processor, the opportunity to the at least two members of the network in response to finding the opportunity based on the at least one shared interest. The method may further include providing, by the processor, a feature associated with the opportunity that allows each of the at least two members to accept the opportunity based on a condition. The condition may include at least one of accepting the opportunity by another of the at least two members, accepting the opportunity by at least one other designated member of the network, and accepting the opportunity by a preset number of the members of the network.

According to another aspect of the present invention, a system for making group opportunity recommendations and reservations may include a processor and a module operable on the processor for searching for an opportunity based on at least one shared interest of at least two members of a network. The system may additionally include a module for transmitting the opportunity to the at least two members of the network in response to finding the opportunity based on the at least one shared interest. The system may further include a module for providing a feature associated with the opportunity that allows each of the at least two members to accept the opportunity based on a condition. The condition may include at least one of accepting the opportunity by another of the at least two members, accepting the opportunity by at least one other designated member of the network, and accepting the opportunity by a preset number of the members of the network.

According to a further aspect of the present invention, a computer program product for making group opportunity recommendations and reservations may include a computer readable storage medium having computer readable program code embodied therewith. The computer readable program code may include computer readable program code configured to search for an opportunity based on at least one shared interest of at least two members of a network. The computer readable program code may additionally include computer readable program code configured to transmit the opportunity to the at least two members of the network in response to finding the opportunity based on the at least one shared interest. The computer readable program code may further include computer readable program code configured to provide a feature associated with the opportunity that allows each of the at least two members to accept the opportunity based on a condition. The condition comprises at least one of accepting the opportunity by another of the at least two members, accepting the opportunity by at least one other designated member of the network, and accepting the opportunity by a preset number of the members of the network.

### BRIEF DESCRIPTION OF THE SEVERAL VIEWS OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIGS. 1A-1C (collectively FIG. 1) are a flow chart of an example of a method for making group travel recommendations and reservations based on shared interests in accordance with an embodiment of the present invention.

FIG. 2 is a block schematic diagram of an example of a system for making group travel recommendations and reservations based on shared interests in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In accordance with an aspect of the invention, interactive advertisements that include travel opportunities may be used for travel bookings or reservations. As used herein, a travel opportunity or opportunity may include but is not necessarily limited to travel to a particular geographic location, attending a particular event, participating in a particular activity or any other type experience. A user or member of a network may accept a travel opportunity or opportunity offer based on a condition or conditions, for example, contingent on selections or acceptance of others in their network or other conditions. As used herein, a network may include but is not necessarily limited to a social network, other type network, online association or the like, or a group of people or users included in an instance of a travel opportunity, including those originally targeted or sent the opportunity and others added to the opportunity either by those already targeted requesting that the opportunity be extended to others or that are added to the opportunity by some other mechanism. A feature may also be provided with a travel opportunity for a user to offer to pay for others in their network or other invitees as defined herein. The system may intelligently and automatically match travel opportunities to at least two individuals or groups of individuals or members of a network based on a history of interactions in the network. The intelligent matching may include using keywords for geographic locations, activities, events and other experiences in social profiles and activity stream histories. The system may prioritize travel opportunities or travel opportunity offers which are likely to be accepted by comparing prices for the user and the group with historical prices.

The system embodies a new advertising model and a new business model where travel services providers, such as airlines, hotels, car rental agencies and other travel services providers can off load additional inventory, extra capacity or availability at discounted rates to groups of people at a time instead of individuals, where marketing, pricing and discounting decisions can be made based on new potential bookings or reservations.

With multiple individual bookings linked together through a common offer, airlines can better and more efficiently rebook travelers in case of travel disruption. Potential groups of travelers may be identified for oversold volunteer situations. Discounted group upgrades can be offered to optimize the use of first class and priority seating especially in cases when the airlines predicted these seats will not be filled with paid upgrades. Customers traveling together who would normally be on unrelated itineraries can be better served.

FIGS. 1A-1C (collectively FIG. 1) are a flow chart of an example of a method 100 for making group travel recommendations and reservations based on shared interests in accordance with an embodiment of the present invention. In block 102, a list of contacts or members in a network with at least one shared interest may be generated. As previously discussed, the network may include, but is not necessarily limited to a social network, other type network, or other online association or the like. The list of contacts or members may be generated by scanning an activity stream or feeds of activities of users on the network for references to geographic locations, activities, events or reference to other items to determine a shared interest or interests. The contact or member list may be based only on linkages or some association between members of the network.

In block 104, a search of the Internet may be periodically performed for discovering travel opportunities. As previously discussed, an opportunity or travel opportunity may include but are not necessarily limited to travel to a particular geographic location, attending a particular event, participating in a particular activities or similar experiences that may correspond to a shared interest or interests between two or more member of the network.

In block 106, a set of geographic locations, activities, events or other experiences found in the search may be tracked or monitored in a database 108. Information associated with the set of geographic locations, activities, events or other experiences may be stored in the database 108 based on keywords commonly associated with such locations, activities, events and experiences found in activity streams or feeds of activities from communications within the network. For instance, Reno/Tahoe, Salt Lake City and Denver may be associated in the database 108 with skiing. Phoenix may be associated with golfing. New York City may be associated with dining out, going to the theatre, night clubs or similar entertainment. Seasonal dates for different locations may also be considered. For example, Reno/Tahoe may be associated with skiing only from November to April and Denver from November to June Information in the database 108 may be defined based on words commonly associated with the places in activity feeds from social networks. Locations, activities, events and experiences or keywords associated with certain locations, activities, events and experiences appearing with a predetermined correlation or frequency in activity streams may be stored in the database 108.

In block 110, the database 108 may be periodically searched for a travel opportunity or opportunities based on at least one shared interest of at least two members of the network. A demand for available travel opportunities may also be made in response to a user viewing a page online related to an opportunity or other action by a user. Potential offers or opportunities for an individual may be identified. A list of opportunities or travel opportunities for a user may be generated. For instance, user A has an interest in skiing and there is a promotion for travel to Salt Lake City in February. The opportunity can be added to the list of potential opportunities for user A.

A list of associated individuals may be generated that are related through a network or social network may be generated who also share a common interest or a related interest. For instance, users B, C and D all have interest in skiing or snowboarding. Users B and C are connected to user A and user D is connected to user B.

The list of travel opportunities may also be prioritized based on predetermined criteria, such as costs, timeframe or duration when the travel opportunity is available, availability of the members or other criteria that may be used to prioritize multiple travel opportunities. Personal calendars of the users or members may be checked through social networking software for availability of the members to accept a travel opportunity for a particular date or time duration. If some participants are not local or near to the location of the opportunity, personal calendars may be checked and special promotions may be checked from travel service providers in the database 108 to find a set of travel opportunities which allow all participants to take advantage of the opportunity at the same time.

In block 112, a determination may be made if a travel opportunity was found. If not, the method 100 may return to block 104 and the method 100 may continue similar to that previously described. If a travel opportunity is found, the method 100 may advance to block 114. In block 114, a determination may be made if the cost and/or other conditions associated with the travel opportunity meet a preset criterion or criteria. The preset criterion or criteria may be defined by one or more of the members. If the cost or other conditions do not meet a preset criteria, the method 100 may return to block 104 and the method 100 may proceed similar to that previously described. If the cost and/or other conditions do meet the preset criteria, the method 100 may advance to block 116 (FIG. 1B). In block 116, the travel opportunity offer may be transmitted to the at least two members of the network.

As an example of finding travel opportunities based on at least one shared interest and transmitting a travel opportunity offer to the members, for each interest that is shared between at least two member of the network, a search may be periodically performed to look for airfare to geographic locations that may correspond to or be related to the shared interest. When the airfare reaches a certain preset threshold for both members, or is below a rolling average for a certain number of days, a message may be transmitted to the at least two members. The threshold price may be preset by one or both members or may be determined based on the destination by a server using historical average prices for airfares to the particular destination. A message may be transmitted to the members, for example, “Member A and you share an interest in activity/event B. Why not go to destination C over dates D1-D2 for only $E total (you pay $F)?” Where B is the shared interest and member A is the other person with whom the interest is shared. Dates D1 and D2 are the dates the airfare was found, $E and $F are the cost for the individual member and both combined respectively. For instance, the system might suggest “Jim and you share an interest in golfing. Why not go to Phoenix on August 2 for only $350 total (you pay $200)?” The user or member may click on a link in the message to review the details of the travel opportunity including travel dates, any activities or events associated with the opportunity, accommodations, or other details. The system may also access a list of cross-promotions for hotels, rental cars, and other features and cross-promotions that may be offered by a travel service provider that may be registered with the system as described herein. For example, a provider of an airline ticket may register an offer for hotels that they may have coordinated with. The system will also suggest hotels and rental cars and other items related to the activity as optional add-ons at this point. If both members accept the travel opportunity, the travel opportunity may be automatically booked or a reservation made. A notification may then be transmitted to both people or members confirming the reservation or booking.

In block 116, the travel opportunity offer may include a feature or multiple features that may be selected by each of the members to specify, for example, a condition or different conditions on which acceptance of the travel opportunity may be based. For example, a condition for accepting the travel opportunity by the member may require acceptance by the other member of the at least two member offered the travel opportunity or acceptance by a preset number of other members of the network; acceptance of the travel opportunity by at least one other designated member of the network or acceptance by an invitee who is not a member of the network. The designated member or invitee may be someone that one of the original members offered the travel opportunity wants to extend the travel opportunity offer.

A feature may also be provided for the member or user to select whether to allow notification of the other member or members about the condition or conditions for acceptance selected or specified by the member.

The travel opportunity may then involve two or more people or members of the network as well as invitees outside the network. As previously discussed, in responding to the travel opportunity offer, a user or member may make his or her acceptance contingent or conditional upon another member or individual or group of members or individuals or preset threshold number of members of a group or network accepting the travel opportunity offer. For instance, a user may check a box next to a person or other member to indicate that they will only accept the travel opportunity if the other member or person accepts as well. The user may also enter a minimum number of people or minimum number of members of the network that need to accept the travel opportunity for the user to accept. For instance, the person may indicate they will only accept if three other people accept that are part of the network and therefore that they know. Bookings for an individual are then contingent upon others accepting and start to be processed as soon as a minimum and internally consistent set of user requirements are fulfilled. For example, if Jim requires Bob to go and Bob requires Phil, the trip is not booked unless Phil also responds saying he will go. A user may make their requirements open to the group, in which case everyone in the group could see the requirements of others and their acceptance state would be shared, or open only to the individual included in the user's conditional acceptance. In which case Bob would get a message saying Jim wants him to go and Phil would get a message saying Bob wants him to go, but Phil would not be able to see that Jim wanted Bob to go. Alternatively, the user may make their requirements totally private.

The travel opportunity may also include a feature to allow one member to pay for the cost of the travel opportunity for at least one other member of the network or to pay for fixed cost of the overall opportunity for all of a set of participants. The travel opportunity may additionally include a feature or option to expand the travel opportunity or offer the travel opportunity to at least one other invitee. The invitee may be another member within the network who did not receive the original travel opportunity or the invitee may be someone outside of the network. The travel opportunity may then be transmitted to the invitee or invitees. Automatic amendments may be made to the opportunity and the total cost based on new participants or users accepting the opportunity.

As previously discussed, a member or user may select or specify to extend the travel opportunity offer to other members of the network or invitees outside the network. A search may then be automatically performed by the method 100 or system for the best possible airfare or travel arrangements for the additional individuals. The travel opportunity offer may be transmitted to the other members and/or invitees and they may view the offer details viewed by others. The member or user selecting an option to extend the travel opportunity to others may also provide information associated with the at least one other member or invitee. The information associated with the at least one other member or invitee may include at least contact information, such as an e-mail address, social network address or other address or contact information. The information provided may also include demographic information for determining whether the same travel opportunity or an asymmetric travel opportunity, as described below, should be sent to the at least one other member or invitee.

The travel opportunity may also include a feature, such as an option or link, to opt out of future travel opportunity offers. The opt out option may include a feature to specify that the member desires to opt out of future travel opportunities associated with at least one of a particular member or contact in the network, a particular geographic location, a particular activity, a particular event or the like.

The travel opportunity offer transmitted to at least two members of the network does not have to be the same or a substantially identical travel opportunity. For example, one or more asymmetric travel opportunities may be transmitted to one or more particular members or invitees in block 116. The one or more asymmetric travel opportunities may each be different from one another and from the original travel opportunity or base travel opportunity that may be offered or transmitted to other members or the majority of other members of the network. For example, an asymmetric travel opportunity may include at least one of transportation originating in a different geographic location or city than the base travel opportunity or other asymmetric travel opportunities offered to other members or invitees; transportation over a different route or by a different carrier than the base travel opportunity or other asymmetric travel opportunities; a different fee structure from the base travel opportunity or other asymmetric travel opportunities; different accommodations, amenities, add-ons or the like compared to the base travel opportunity or other asymmetric travel opportunities; as well as other differences that may be based on different circumstances between the different members of the network or other invitees.

In block 118, a determination may be made whether the travel opportunity offer was accepted and whether the acceptance was conditional. If the travel opportunity is not accepted, the method 100 may return to block 104 (FIG. 1A) and the method 100 may proceed similar about previously described. If the travel opportunity offer is accepted, the method 100 may advance to block 120. In block 120, the travel opportunity may be automatically booked or a reservation may be made for the travel opportunity for at least the two members of the network. Detailed offer documents and information may be automatically transmitted to those accepting the travel opportunity. The acceptances may also be automatically transmitted to the service provider or service providers for activation of the travel opportunity offer. For example, bookings or reservations may be made for the people accepting the travel opportunity. The method 100 may then advance to block 124 which is described below.

If the acceptance in block 118 was conditional based on acceptance by at least one other member, a particular member or group of members, a preset number of members, at least one invitee or based on some other condition, the method 100 may advance to block 122.

In block 122, the condition or conditions, or a notification of the condition or conditions may be transmitted to at least one other member of the network, invitee or user in response to the member or user setting or selecting the condition and selecting an option to allow others to view or receive the condition or conditions.

In block 124, a determination may be made if an offer or option to pay for at least one other member or invitee was made or exists. If so, the method 100 may advance to block 126. In block 126, a notification may be transmitted to at least one second member or invitee in response to the first member offering to pay. The method 100 may then return to block 118 and the method may proceed similar to that previously described.

If an offer to pay for at least one other person does not exist in block 124, the method 100 may advance to block 128. In block 128, a determination may be made if there was an option selected to extend the travel opportunity offer to at least one invitee and there was no offer to pay for the at least one invitee by another. If there is at least one invitee, the method 100 may advance to block 130. In block 130, the travel opportunity offer may be transmitted to the at least one invitee.

If there is no invitee in block 128, the method 100 may advance to block 132. In block 132, the method 100 may wait for an action from the member or user or until a predetermined time period expires or times-out. The method 100 may return to block 118 in response to an input being received from the member or user and the method 100 may continue similar to that previously described. The input may be an acceptance of the travel opportunity offer, a conditional acceptance or the offer may be declined.

If a predetermined period of time expires or times-out in block 132, the method 100 may advance to block 134 (FIG. 1C). In block 134, a determination may be made whether a particular member or members need to accept the travel opportunity offer or if a certain number or set of members or users need to accept for the conditional acceptance to be satisfied.

In block 136, information associated with the travel opportunity and conditional acceptances and bookings or reservations may be transmitted to one or more services providers associated with the travel opportunity in response to either expiration of a preset time after the travel opportunity was offered or a preset time before the travel date associated with the travel opportunity. Examples of service providers may include, but not necessarily limited to, airlines, cruise ship companies, resorts, hotels, golf courses, recreational areas or other type service providers. One or more of the service providers may establish incentives to encourage any remaining members or invitees to accept the travel opportunity. For example, the incentives may include discounts, additional services, upgrades or other incentives to encourage the remaining members or invitees to accept.

In block 138, the incentives may be received from the service provider or service providers along with any instructions or criteria for offering the incentives to the remaining members or invitees who have not accepted the travel opportunity.

In block 140, the incentives may be transmitted to selected remaining members of the network or invitees to accept the travel opportunity offer in response to also receiving the incentives. The method 100 may then returned to block 118 (FIG. 1B). As previously discussed, in block 118, acceptances of the travel opportunity advance to block 120 and may be received by the system. The travel opportunity may be booked or reservations made and confirmation information is transmitted to those accepting the offer.

As a further example of blocks 138 and 140, after a preset time period after the travel opportunity offer is transmitted or a preset time period before the travel date, if some users have accepted the travel opportunity and made contingent booking, but not all users have accepted, information (potentially anonymous) about the potential booking may be shared with the travel services provider, such as an airlines, cruise ship company, resort, hotel, theme park, etc. The system may facilitate the travel services provider extending an offer for discounts, additional services, coupons, upgrades, discounts or coupons for future travel in order to entice the remaining members or invitees to accept the travel opportunity. Since there may be contingent or conditional acceptances or bookings that the service provider becomes aware of, multiple bookings or reservations may be closed as a result of a single enticement or incentive. The information transmitted to the travel services provider may include information about the offer made and respondents choices along with an offer code. The travel services provider may send a message back to the system with a message code to relate to the original travel opportunity and may offer additional enticements or incentives keyed to participants by anonymous participant IDs or to real names. The travel services provider may transmit information which may include more detail about the travel opportunity offer to be delivered only upon acceptance of the offer. The information may be a Hypertext Mark-up Language (HTML) document or other type format document. This additional information or document may include bar codes that may be used for a drink, meal coupons or other items. The offers may be transmitted to the individual participants through e-mail or messaging in a social network system. Upon acceptance of the travel opportunity offer, detailed offer documents may be transmitted to those accepting. The service provider may also be notified of acceptance which may be used for activation of the offer.

In block 142, a multi-person travel opportunity offer may be received from a travel services provider. The offer may be received by a system for making group travel recommendations and reservations, such as system 200 described with reference to FIG. 2. The multi-person travel opportunity provided by the travel services provider may be registered with the system.

In block 144, the multi-person travel opportunity may be loaded on the database 108 (FIG. 1B). The multi-person travel opportunity may include percentage off offers for multiple bookings or routes or destinations with special discounts for multiple individuals traveling. For instance, an airline may make a promotion that requires at least 5 people traveling to Paris and may register this promotion with the system. The offer may be made contingent on all the individuals traveling on the same final leg or a particular final leg of the journey even though they are traveling from different origin cities. Similar to that previously described, users may be matched to the travel opportunity based on social networks and shared interests. In this case, travel opportunity offers may be transmitted to the users or at least two members of the network based on a shared interest or interests and facilitates booking. The travel services provider or airline's registration of the travel opportunity offer eliminates the need to search for matching airfares in an external booking service or over the Internet. The service provider may register by providing details of the opportunities and offers. The details may be provided to a server or other system providing the opportunities as described herein. The service provider may also provide a web service that may be used by the system or method described herein to search for offers.

The system may use the database 108 of individuals and shared interests to make available to travel services providers anonymous statistics about potential sales which can be used to make discount and pricing decisions by the travel services providers.

FIG. 2 is a block schematic diagram of an example of a system 200 for making group travel recommendations and reservations based on shared interests in accordance with an embodiment of the present invention. The method 100 of FIG. 1 and other exemplary features described herein with reference to FIG. 1 may be embodied in or performed by the system 200 or components of the system 200 as described below. The system 200 may include a computer system 202 for use by a user 204 for responding to group travel recommendations and marking bookings or reservations similar to that described herein. The computer system 202 may be any type of computer device capable of performing the functions or operations described herein.

The computer system 202 may include a processor 206 to control operation of the computer system 202 and a file system 208, memory or similar data storage device. An operating system 210 may be stored on the file system 208 for running or operating on the processor 206. A communications app or application 212 may be stored on the file system 208 for operation on the processor 206. The communications app 212 may operate in association with a communications service, IM, chat, a social network (Facebook®, LinkedIn®, etc.) or other type communications service for which contacts or members of a network may be determined and their shared interests may be tracked similar to that described herein. Activity streams or feeds of activities may be scanned to determine shared interests similar to that described herein.

An email app 214 or application may also be stored on the file system 208 for operation on the processor 206. The email app 214 may be used to determine shared interests similar to that described herein and also the receive transmitted travel opportunity offers and to accept travel opportunity offers similar to that described herein.

Other applications 216, software programs or the like may also be stored on the file system 208 for operation on the processor 206. A web or Internet browser 218 may also be stored on the file system 208 for accessing one or more resources, such as a server 220 via the network 222. The server 220 may host a communications service or system or social network as defined herein. The network 222 may be the Internet, intranet or other network.

In accordance with an embodiment, the server 220 or processing device may include a module 224 for group travel opportunity recommendations and reservations or bookings similar to that described herein. The method 100 may be embodied in and performed by the module 224 or portions of the method 100 may be performed by the module 224 with other portions being performed by other components of the system 200.

A database 226 may be associated with the server or processing device 220. The database 226 may be the same as the database 108 and be used to store information associated with geographic locations, activities, events and other experiences for providing travel opportunities similar to that described herein. The database 226 may also include lists of contact or members of a network and shared interests between the members for matching members with shared interests to travel opportunities as described herein.

One of more servers 228 associated with one or more travel services providers may also be accessed via the network 222 for providing the travel opportunities and booking the travel opportunities as described herein.

The computer system 202 may also include a display 230 for presenting user interfaces, graphical displays as well as other content as described herein. The computer system 202 may also include a speaker system 232 for presenting any audio content. The computer system 202 may additionally include a microphone 234 for the user 204 to aurally communicate via the computer system 202 or control the computer system 202 via voice commands.

The computer system 202 may further include one or more input devices, output devices or combination input/output devices, collectively I/O devices 236. The I/O devices 236 may include a keyboard, pointing device, such as a mouse or other computer pointing device, disk drives and any other devices to permit a user, such as user 204, to interface with and control operation of the computer system 202 and network resources, such as servers 220 and 228. The applications 212-216 may be loaded on the computer system 202 from a computer program product, such as computer program product 238 using one of the input devices 236. The computer program product 236 or a similar computer program product may also be used to load the module 224 on the server 220. The computer program product 238 may be embodied in a form similar that previously described.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

1. A method for making group opportunity recommendations and reservations, the method comprising:
searching, by a processor, for an opportunity based on at least one shared interest of at least two members of a network;
transmitting, by the processor, the opportunity to the at least two members of the network in response to finding the opportunity based on the at least one shared interest;
providing, by the processor, a feature associated with the opportunity that allows each of the at least two members to accept the opportunity based on a condition, wherein the condition comprises at least one of accepting the opportunity by another of the at least two members, accepting the opportunity by at least one other designated member of the network, and accepting the opportunity by a preset number of the members of the network.

2. The method of claim 1, further comprising transmitting a notification about the condition for accepting the opportunity to at least one other member in response to a first member of the at least two members setting the condition for accepting the opportunity and authorizing notification of the condition to the at least one other member.

3. The method of claim 1, further comprising providing another feature associated with the opportunity that allows each of the at least two members to offer to pay a cost of the opportunity for at least one other member of the network.

4. The method of claim 3, further comprising transmitting a notification to the at least one other member of the network in response a first member of the at least two members offering to pay the cost of the opportunity for the at least one other member.

5. The method of claim 1, further comprising providing another feature associated with the opportunity for offering the opportunity to at least one invitee other than the at least two members.

6. The method of claim 5, wherein the at least one invitee is not a member of the network or is a further member of the network.

7. The method of claim 1, further comprising providing another feature associated with the opportunity to opt out of receiving future opportunity offers.

8. The method of claim 7, further comprising allowing opting out of receiving the future opportunity offers associated with at least one a particular member of the network, a particular geographic location, a particular event and a particular activity.

9. The method of claim 1, further comprising transmitting at least one asymmetric opportunity to at least one particular member of the network, the at least one asymmetric opportunity comprising an attribute that is different from the opportunity.

10. The method of claim 10, wherein the at least one asymmetric opportunity comprises at least one of transportation originating in a different geographic location than the opportunity, transportation over a different route than the opportunity, a different fee structure from the opportunity, and a different accommodation than the opportunity.

11. The method of 1, further comprising generating a list of contacts in a social network with the at least one shared interest, the list of contacts with the at least one shared interest corresponding to members of the network with the at least one shared interest.

12. The method of claim 11, further comprising determining the at least one shared interest by scanning an activity stream of the contacts in the social network for references to one or more geographic locations, one or more activities and one or more events.

13. The method of claim 1, further comprising transmitting information associated with the opportunity, the condition for accepting the opportunity and members who have accepted the opportunity to a service provider in response to one of expiration of a preset time period after transmitting the opportunity and a preset time period before a travel date associated with the opportunity.

14. The method of claim 13, further comprising:
receiving, by a system for group opportunity recommendations and reservations, an incentive from the service provider for accepting the opportunity; and
transmitting, by the system, the incentive to at least a remaining member that has not accepted the opportunity.

15. The method of claim 1, further comprising:
checking a personal calendar of the at least two members for availability of the at least two members with respect to the opportunity; and
coordinating the opportunity with the availability of the at least two members.

16-20. (canceled)
